(19) United States
(12) Patent Application Publication
(10) Pub. No.: US 2001/0043236 A1
(43) Pub. Date: Nov. 22, 2001

(54) CAD system

(75) Inventor: Takashi Yamamoto, Shizuoka (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/875,888

(22) Filed: Jun. 8, 2001

Related U.S. Application Data
(63) Continuation of application No. PCT/JP99/01337, filed on Mar. 17, 1999.

(51) Int. Cl. G06T 15/10; G06T 15/20; G06F 3/14

(52) U.S. Cl. 345/781; 345/427

(57) ABSTRACT

A CAD system with a feature selection mechanism for helping the user to specify a particular geometric feature of a three-dimensional object. A two-dimensional drawing generator produces a two-dimensional drawing that represents a given three-dimensional model in two-dimensional form. The produced drawing is displayed on a monitor screen by a two-dimensional drawing display controller. A graphic element selection unit allows the user to specify a particular graphic element being displayed as part of the two-dimensional drawing on the screen. The selected graphic element has been derived from some feature of the three-dimensional model. A three-dimensional feature selection unit identifies that feature and sets it to a selected state for further manipulation. The feature selected in this way is emphasized on the monitor screen.

### BACKGROUND OF THE INVENTION

1. Field of the Invention

The present invention relates to computer-aided design (CAD) systems, and particularly to a CAD system with a modeling mechanism that uses both two-dimensional and three-dimensional views of a solid object in an associated manner.

2. Description of the Related Art

Three-dimensional CAD systems are widely used today as practical design tools for mechanical components. Particularly for solid object designs, techniques called the “feature-based parametric modeling” have become prevalent. As its name implies, the feature-based parametric modeling method represents an object as parametric relations of key geometric features. One of its advantages is that the geometric definition of each feature can be varied at any time in the design process, providing greater flexibility.

FIG. 18 shows an example of a feature-based parametric design. This example involves two simple three-dimensional geometric entities, or features, 101 and 102; the desired shape 103 is obtained by performing boolean subtraction of the second feature 102 from the first feature 101. The parametric approach permits the designer to refine his/her design easily. He/she can resize, move, or delete existing features, as well as add a new feature to the design. For example, modifying the width of the second feature 102 from W to W′ will yield a different three-dimensional object 104 characterized by a wider groove.

While the feature-based parametric modeling has various advantageous aspects as described above, many designers actually begin with the sketching of their initial design ideas on a traditional two-dimensional drawing, rather than taking a feature-based approach from the outset. After that, they build a three-dimensional model on the basis of the geometric definitions represented in the two-dimensional drawing. In other words, most three-dimensional mechanical CAD designs require the involvement of a two-dimensional design phase.

To make the above process easier, researchers have proposed various methods that incorporate a two-dimensional approach into three-dimensional modeling, such as forming a three-dimensional object from a two-dimensionally defined profile. The Unexamined Japanese Patent Publication No. 9-22421 (1997) shows an example of such efforts. One technique disclosed in this patent application enables a three-dimensional model to be produced even from a somewhat incomplete two-dimensional sketch lacking explicit definitions of some elements.

The user of a feature-based CAD system often needs to pick a particular feature from among those constituting a three-dimensional model, no matter what method was used to create it at the early design stage. In conventional three-dimensional CAD systems, one common way to select an element is to place the mouse pointer on a surface or edge of a desired element and click the mouse button, as illustrated in FIG. 19. FIG. 19 shows a three-dimensional model 110 consisting of two features 111 and 112. The user operates the mouse to move the pointer on the feature 112 and press the button, thereby setting it to the selected state for further editing. In this way, the user identifies and selects a desired feature, viewing the monitor screen where a three-dimensional projection view of the design is displayed.

However, since he/she took a two-dimensional approach to built his/her initial model, the user may find it difficult to locate an intended part of the model from among those contained in a three-dimensional view. Note that the original two-dimensional drawing embodies the designer's intent about, for example, how to process each part of the workpiece to yield a desired shape. In this sense, the designer's complete ideas, including the detailed attributes of each element, are expressed in the two-dimensional drawing that he/she has drafted. This kind of information is, however, not necessarily apparent in the three-dimensional views produced automatically from the original two-dimensional drawing, which could be the reason for the perceived difficulty in picking an element.

The above-discussed problem is considered to become more serious, as more sophisticated techniques for automatic conversion from two-dimensional drawings to three-dimensional models emerge. Picking a feature is one of the essential operations in a feature-based parametric design process. Therefore, the improvement in this area is critically important in terms of the usability of three-dimensional CAD systems.

### SUMMARY OF THE INVENTION

In view of the foregoing, it is an object of the present invention to provide a CAD system which allows the user to specify a particular feature contained in a three-dimensional design.

To accomplish the above object, according to the present invention, there is provided a computer-aided design (CAD) system having a modeling mechanism that uses both two-dimensional and three-dimensional views of a solid object in an integrated manner. This system comprises the following functional blocks: a two-dimensional drawing generator which generates a two-dimensional drawing that represents a three-dimensional model being defined as a collection of three-dimensional geometric features; a two-dimensional drawing display controller which displays the generated two-dimensional drawing on a monitor screen; a graphic element selection unit which selects a graphic element contained in the two-dimensional drawing being displayed on the monitor screen; and a three-dimensional feature selection unit which identifies one of the three-dimensional geometric features that corresponds to the graphic element selected by the graphic element selection unit, and sets the identified geometric feature to a selected state for further manipulation.

The above three-dimensional CAD system operates as follows. The two-dimensional drawing generator produces a two-dimensional drawing that represents a three-dimensional object design. The produced two-dimensional drawing is displayed on the monitor screen by the two-dimensional drawing display controller. When the graphic element selection unit identifies a particular graphic element specified by the user, the three-dimensional feature selection unit determines which feature corresponds to the specified graphic element and sets that feature to the selected state.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a three-dimensional CAD system according to the present invention;

FIG. 2 is a hardware block diagram of the proposed three-dimensional CAD system;

FIG. 3 shows functional blocks of the proposed three-dimensional CAD system;

FIG. 4 is a flowchart of the feature selection processing according to the present invention;

FIG. 5 shows how a three-dimensional view of a feature is created from its two-dimensional drawing;

FIG. 6 shows the association between a feature of a three-dimensional object and its projection views on a monitor screen;

FIG. 7 shows the profile of each feature that forms a three-dimensional object;

FIG. 8 shows a two-dimensional drawing where a projection view of each feature profile is overlaid;

FIG. 9 shows how to select a feature;

FIG. 10 shows a monitor screen layout of a CAD system;

FIG. 11 shows an example of a feature defined on a two-dimensional drawing that is intended for an additional machining operation;

FIG. 12 shows an updated three-dimensional model after the specified machining operation is applied;

FIG. 13 shows a drawing on which the projection views of the feature in question are superimposed;

FIG. 14 shows another example of a three-dimensional object;

FIG. 15 shows a three-dimensional representation of the object when the hidden line viewing function is disabled;

FIG. 16 shows a three-dimensional representation of the same object when the hidden line viewing function is enabled;

FIG. 17 shows a two-dimensional drawing which appears on the monitor screen;

FIG. 18 shows the concept of feature parametric modeling; and

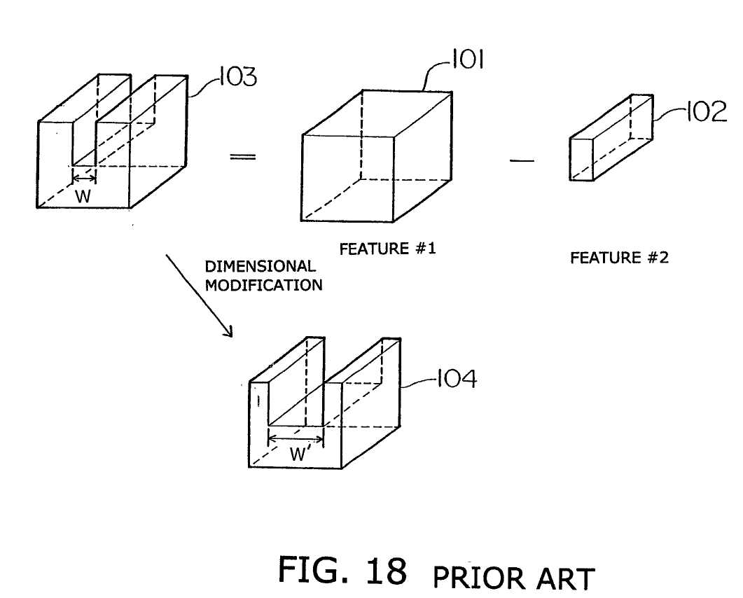

FIG. 19 shows a screen view of a conventional three-dimensional CAD system, in which the user is attempting to select a particular feature.

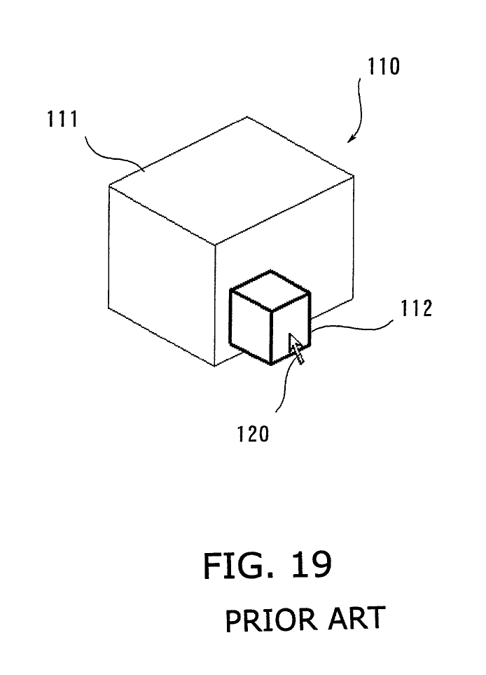

### DESCRIPTION OF THE PREFERRED EMBODIMENTS

Preferred embodiments of the present invention will be described below with reference to the accompanying drawings.

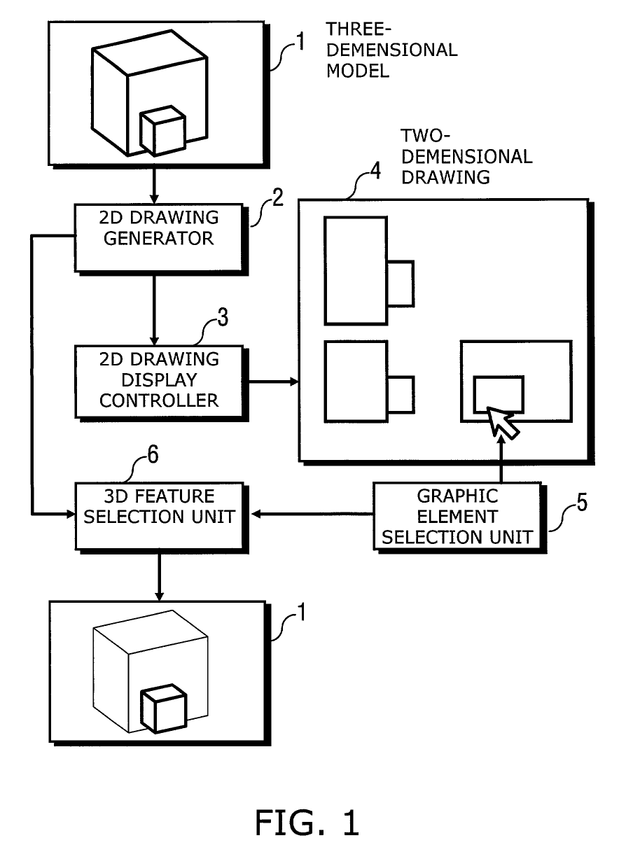

FIG. 1 is a conceptual view of a three-dimensional CAD system according to the present invention. For easier selection of a geometric feature of a given three-dimensional model 1, this CAD system employs the following functional blocks: a two-dimensional (2D) drawing generator 2, a two-dimensional drawing display controller 3, a graphic element selection unit 5, and a three-dimensional (3D) feature selection unit 6. The two-dimensional drawing generator 2 generates a two-dimensional drawing 4 by two-dimensionally drawing various views of the three-dimensional model 1 which is composed of a plurality of three-dimensional geometric features. The two-dimensional drawing display controller 3 displays the generated two-dimensional drawing 4 on a monitor screen. The graphic element selection unit 5 picks, or selects, one of the graphic elements constituting the two-dimensional drawing 4 on the monitor screen. The three-dimensional feature selection unit 6 identifies and selects a three-dimensional geometric feature that corresponds to the selected graphic element.

The above three-dimensional CAD system operates as follows. When a three-dimensional model 1 is given, the two-dimensional drawing generator 2 produces a two-dimensional drawing 4 which represents the given three-dimensional model 1 in two-dimensional form. The produced two-dimensional drawing 4 is passed to the two-dimensional drawing display controller 3 for display on the monitor screen. The graphic element selection unit 5 allows the user to specify a particular graphic element being displayed as part of the two-dimensional drawing 4. It picks this graphic element and supplies the information to the three-dimensional feature selection unit 6. The selected graphic element has been derived from some part of the three-dimensional model 1. The three-dimensional feature selection unit 6 identifies that original part, or feature, of the three-dimensional model 1 and selects it for further manipulation. The feature selected in this way is emphasized on the monitor screen.

As seen from the above, the CAD user can pick a particular feature of a three-dimensional object for further manipulation, by specifying a part of the two-dimensional views of that object. This function is useful when the three-dimensional model of interest has some features that are hard to identify or specify on its three-dimensional view.

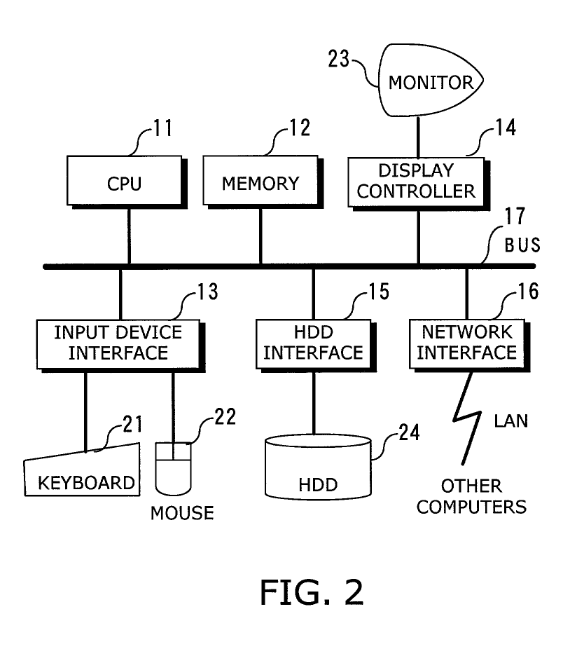

The next section describes a more specific implementation of the proposed three-dimensional CAD system. FIG. 2 is a hardware block diagram of a three-dimensional CAD system according to the present invention. This system employs a central processing unit (CPU) 11, which plays a main role in three-dimensional geometry data processing. The CPU 11 carries out various processing tasks, as well as controlling various devices and interfaces connected to a bus 17. Such components include a memory 12, an input device interface 13, a display controller 14, a hard disk drive (HDD) interface 15, and a network interface 16.

The memory 12 serves as temporary storage for application programs and scratchpad data that the CPU 11 executes and manipulates at runtime. The input device interface 13 receives input signals from a keyboard 21 and a mouse 22 and supplies them to the CPU 11. The display controller 14 receives image data from the CPU 11 and converts it into video signals for display on the screen of a monitor unit 23. The HDD interface 15 provides the CPU 11 with a data transfer function to save and retrieve data to/from a hard disk unit 24. Data stored in the hard disk unit 24 includes three-dimensional CAD programs and geometry data. The network interface 16 permits the CPU 11 to send and receive data to/from other computers over a local area network (LAN).

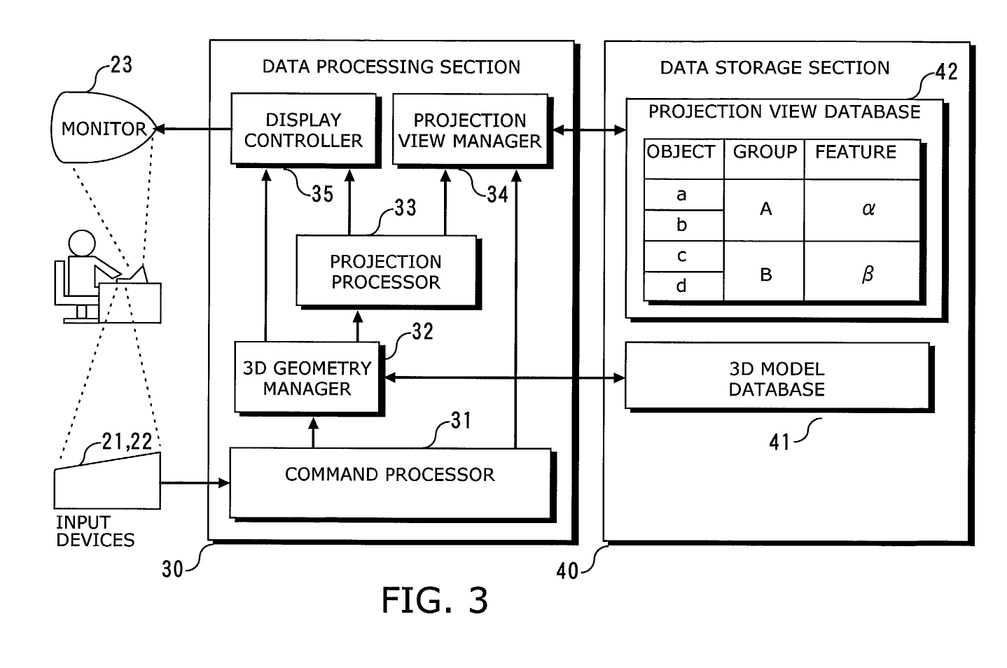

The above computer hardware serves as a platform for executing a three-dimensional CAD program in which the feature selection mechanism of the present invention is implemented. With this CAD program, the CPU 11 will provide various functions depicted in a functional block diagram of FIG. 3. Note that FIG. 3 shows only a part of the system that is related to the present invention. The implemented data processing functions are divided into two groups: data processing section 30 and data storage section 40.

The data processing section 30 comprises the following blocks: a command processor 31, a 3D geometry manager 32, a projection processor 33, a projection view manager 34, and a display controller 35. The command processor 31 receives a sequence of input signals from input devices (e.g., keyboard 21 and mouse 22 in FIG. 2) and interprets it as a user command. Parsing a given command, the command processor 31 triggers the 3D geometry manager 32 and other blocks in the data processing section 30 to invoke necessary processing tasks to execute the user command. For example, the command processor 31 directs the projection view manager 34 to retrieve all the features constituting the three-dimensional model for projection processing. (Depending on the complexity of the model, the resultant views could be too complicated for the user to find and pick a particular feature. If this is the case, the CAD system sets an appropriate threshold that limits the number of detailed features to be included in the projection views.) The command processor 31 may also receive a selection command for a certain graphic element on the two-dimensional drawing. In that case, it requests the projection view manager 34 to find a feature that corresponds to the selected graphic element.

Three-dimensional geometry data of the current geometry manager 32 manages this data, reading and writing records as requested by the command processor 31. The three-dimensional model is constructed by using feature-based parametric modeling techniques. The geometric definition of each individual feature, as opposed to the shape of the final object, is referred to as the “form” of a feature. The form of each feature is structured such that a desired object will be obtained by applying boolean addition, subtraction, and multiplication operations to a plurality of features. More specifically, it is possible to make a hole to an object by subtracting a feature from that object. It is also possible to create an protrusion on an object by adding a feature to that object.

When displaying a three-dimensional view of the object, the 3D geometry manager 32 retrieves its geometry data from the 3D model database 41 and passes it to the display controller 35. When producing a two-dimensional drawing of the object, the 3D geometry manager 32 passes the retrieved geometry data to the projection processor 33.

Based on the geometry data supplied from the 3D geometry manager 32, the projection processor 33 creates a projection view of each feature on an appropriate class. The term “class” refers to a hierarchically structured two-dimensional drawing which has a three-dimensional line of sight and supports overlaid views. The projection view classes should be system-defined classes in order to avoid writing them directly to user-defined classes. Such classes are referred to herein as “search classes.” The third angle projection is commonly used as the standard method of multiple view arrangement in mechanical drawings, where each view is drawn on a class having a particular line of sight in the three-dimensional space. Accordingly, the projection processor 33 creates the views of features in such a way that the line of sight defined for each feature's profile view is aligned with that of the class of one of the third-angle projection views contained in the two-dimensional drawing. The resultant two-dimensional graphic elements (i.e., the outcome of the projection processing) are passed to the projection view manager 34 and display controller 35.

One function of the projection view manager 34 is to save the data of two-dimensional graphic elements supplied from the projection processor 33 into the projection view database 42 in the data storage section 40. Another function is to serve the command processor 31 by finding a feature that is associated with a particular graphic element selected from among those shown in the projection view. More specifically, when a certain two-dimensional graphic element is specified by the command processor 31, the projection view manager 34 searches the projection view database 42 to identify the group to which the specified graphic element belongs, and then it finds a feature corresponding to that element group. The projection view manager 34 returns this search result to the command processor 31.

The display controller 35 produces screen images of the three-dimensional object and two-dimensional graphic elements, based on the data supplied by the 3D geometry manager 32 and projection processor 33. When displaying the projection view of features, the display controller 35 draws two-dimensional graphic elements of the search class with a relatively higher intensity, compared to those of other classes, so that the search-class elements will be distinguishable from others. The same visual effect may also be obtained by assigning a normal display intensity to search-class elements and a lower intensity to the other elements. Besides being distinguishably displayed on the screen, the search-class elements are entitled as user-selectable elements, while the graphic elements of other classes are masked. With this setup, the user can pick a search-class element selectively, excluding the other elements on the same screen.

As previously mentioned, the data storage section 40 maintains geometry information in its 3D model database 41 and projection view database 42. More specifically, the 3D model database 41 stores coordinates, dimensions, constraints, and other data that characterize geometric features forming a three-dimensional model. While no limitations are intended, it is assumed here that each feature is defined as the extrusion of a specific two-dimensional profile. That is, a three-dimensional feature is created by extruding a given planer surface along its perpendicular axis for a certain distance, or depth.

The projection view database 42, on the other hand, stores records of the projected graphic elements, classifying them into groups. Every two-dimensional shape is represented as a collection of fundamental graphic elements, or primitives, such as line segments. A rectangle, for example, consists of four line segments connected at right angles. In this sense, the primitives of a certain two-dimensional shape form a single group, and every group of primitives derives from a particular geometric feature. The projection view database 42 maintains such primitive groups in association with the identifier of their original feature.

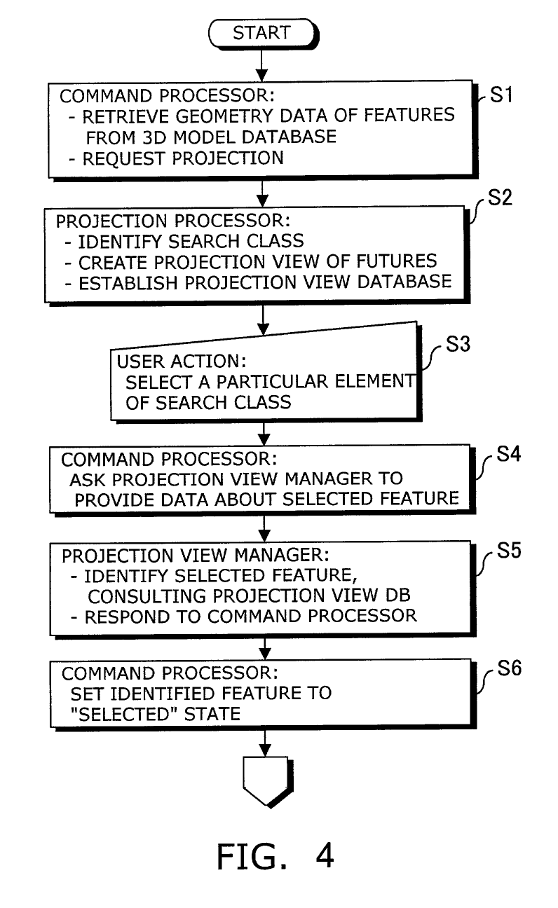

The above-described three-dimensional CAD system enables the user to select one of the features constituting a three-dimensional object indirectly by specifying its corresponding graphic element on a two-dimensional projection drawing. FIG. 4 is a flowchart of this feature selection processing.

(S1) According to a command given from the user, the command processor 31 requests the 3D geometry manager 32 to extract the form (i.e., the geometric definition of a feature) of every feature that the user may select. The 3D geometry manager 32 responds to the request by retrieving relevant form definitions out of the 3D model database 41 and passing them to the projection processor 33. In parallel to the above processing, the command processor 31 directs the projection view manager 34 to prepare for projection views for later searching operations.

(S2) The projection processor 33 obtains a system-defined search class that can be overlaid on a two-dimensional drawing, and on that class, it creates a projection view of each feature. The resultant projection view data is then passed to the projection view manager 34 and display unit 35. The projection view manager 34 enters the received data to the projection view database 42, while the display controller 35 outputs the projection views to the monitor unit.

(S3) Having finished the above steps S1 and S2, the command processor 31 goes into a waiting state in which it waits for a user action. At this step S3, the user is expected to specify a particular graphic element on the search class.

(S4) Upon reception of a user command that indicates a particular graphic element on the monitor screen, the command processor 31 asks the projection view manager 34 to provide data about the feature corresponding to that specified graphic element.

(S5) The projection view manager 34 identifies which feature the user has selected, consulting the projection view database 42. It notifies the command processor 31 of the identified feature.

(S6) The command processor 31 sets the identified feature to a “selected” state, commanding the 3D geometry manager 32 to redraw the three-dimensional view of the design, such that the feature selected by the user will be emphasized. Out of the 3D model database 41, the 3D geometry manager 32 retrieves geometry data of the three-dimensional model being processed. It then supplies the retrieved data to the display controller 35, requesting that the object be displayed with emphasis on the feature selected by the user. More specifically, the 3D geometry manager 32 directs the display controller 35 to highlight the specified feature on the three-dimensional view. The display controller 35 redraws it accordingly.

Through the above-described steps, the proposed system enables the user to select a particular geometric feature of a three-dimensional object of interest, exploring on its two-dimensional views (i.e., orthographic projection views). Those steps are followed by a series of operations to manipulate the selected feature. Since the methods to be used in such manipulation operations are known in the present technical field, no further details will be discussed here.

Referring to the remaining drawings, the next section will describe how a three-dimensional object is defined and how its feature is selected in a CAD system with integrated two- and three-dimensional modeling functions.

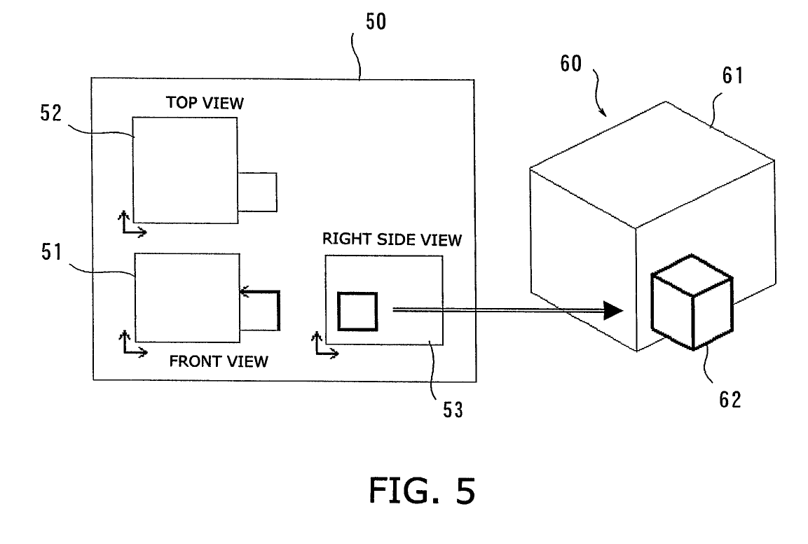

FIG. 5 shows how a three-dimensional view of an object is created from its two-dimensional drawing. The left-hand half of FIG. 5 presents a two-dimensional drawing 50 containing a front view 51, a top view 51, and a right side view 53. This type of two-dimensional drawing is known as the orthographic projection views. The three views are two-dimensional representations of a three-dimensional model 60, whose design has started with a single feature 61. Suppose that the user is now adding another geometric feature 62 to the model 60. He/she first defines a desired profile on the right side view 53 and then gives a depth to it on the front view 51, thereby creating an extruded feature 62 on the two-dimensional drawing 50. Based on this geometric specification, the 2D-3D integrated CAD system calculates the three-dimensional properties of the feature 62 and updates the three-dimensional model 60 with them.

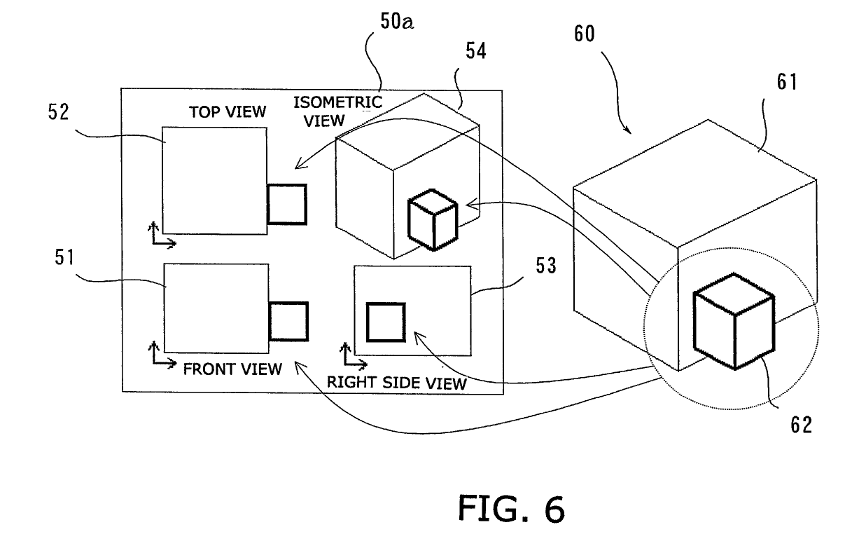

FIG. 6 shows the association between the new feature 62 and its views on a monitor screen. Besides the orthographic projection views explained in FIG. 5, the monitor screen 50a of FIG. 6 contains an isometric projection view 54 of the three-dimensional model 60. This pictorial drawing 54 is an example of what has been referred to as the “three-dimensional view.” Various types of axonometric, oblique, and perspective projections fall into the category of three-dimensional views. Referring to FIG. 6, the newly added feature 62 appears in each of those four different views.

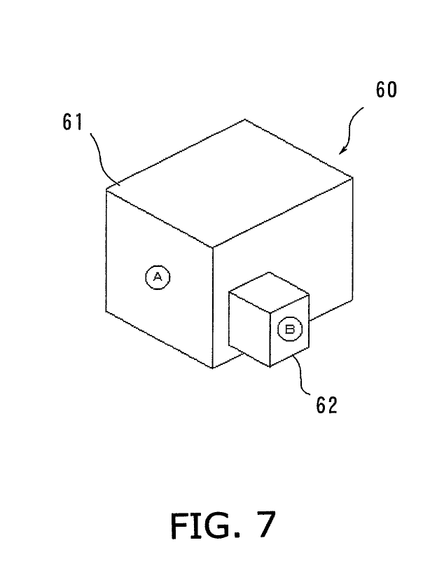

The three-dimensional model 60 now consists of two features 61 and 62 as shown in FIG. 7, each of which has a particular profile shape and depth. In the example of FIG. 7, the profiles of the features 61 and 62 are labeled “A” and “B,” respectively. Consider here that the user has requested the CAD system to show those profiles. In response to this request, the command processor 31 directs the 3D geometry manager 32 to retrieve the relevant geometry data from the 3D model database 41. When the data is retrieved, it then directs the projection processor 33 to create projection views that represent the profile of each feature 61 and 62. The projection processor 33 creates the requested “feature profile views” as search-class entities and sends them to the projection view manager 34. The projection view manager 34 stores them in the projection view database 42 as new projection view records. The records are also supplied to the display controller 35 for the purpose of display on the monitor screen, in the process of which each profile view is overlaid on an appropriate view plane within the two-dimensional drawing of the three-dimensional model 60.

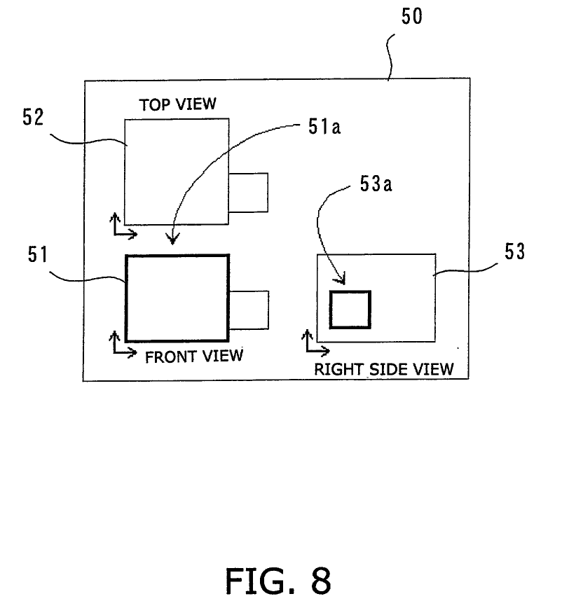

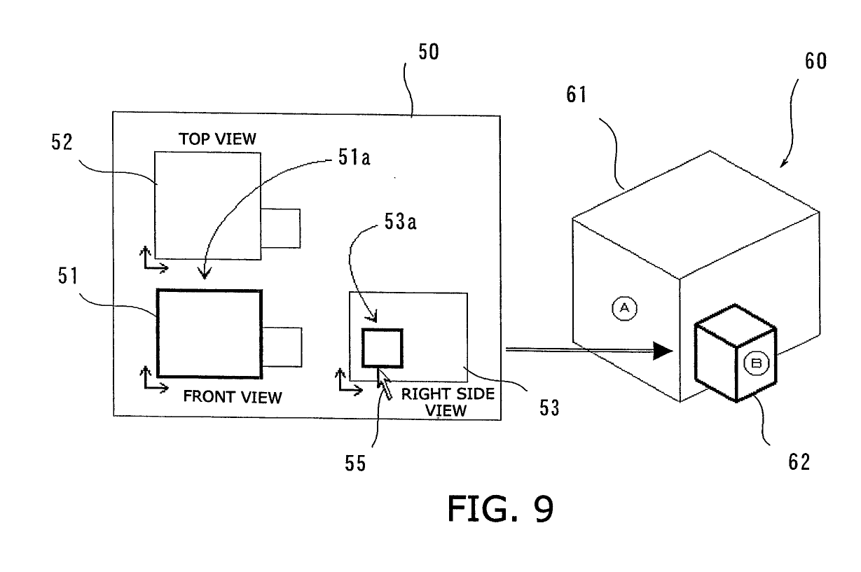

FIG. 8 shows the resultant two-dimensional drawing 50 with the overlaid feature profile views 51a and 53a. That is, the profile view 51a of the first feature 61 is shown in the front view 51, and the profile view 53a of the second feature 62 in the right side view 53. In an attempt to choose a particular feature, the user places the mouse pointer at his/her desired feature profile view and presses the mouse button, as shown in FIG. 9. In the example of FIG. 9, the user clicks on the profile view 53a of the second feature 62, thereby sending a selection command signal to the command processor 31.

Reading out the mouse pointer position, the command processor 31 investigates which graphic element, or primitive, has been clicked by the user, and it sends the information to the projection view manager 34. The projection view manager 34 then searches the projection view database 42 and identifies the group to which the clicked graphic element belongs, and thus the feature corresponding to that group. It sends the identifier of the feature back to the command processor 31, informing that the user has expressed his/her intention to manipulate the feature 62 by clicking the projected section 53a. Accordingly, the command processor 31 sets the feature 62 to the selected state for further manipulation, as well as commanding the three-dimensional geometry manager 32 to emphasize the feature 62 on the monitor screen. The three-dimensional geometry manager 32 then directs the display controller 35 to partly redraw the three-dimensional model 60 in such a way that the feature 62 will be intensified distinguishably from others. According to this direction, the display controller 35 updates the screen.

The next section presents another example of how the proposed 2D-3D integrated CAD system operates.

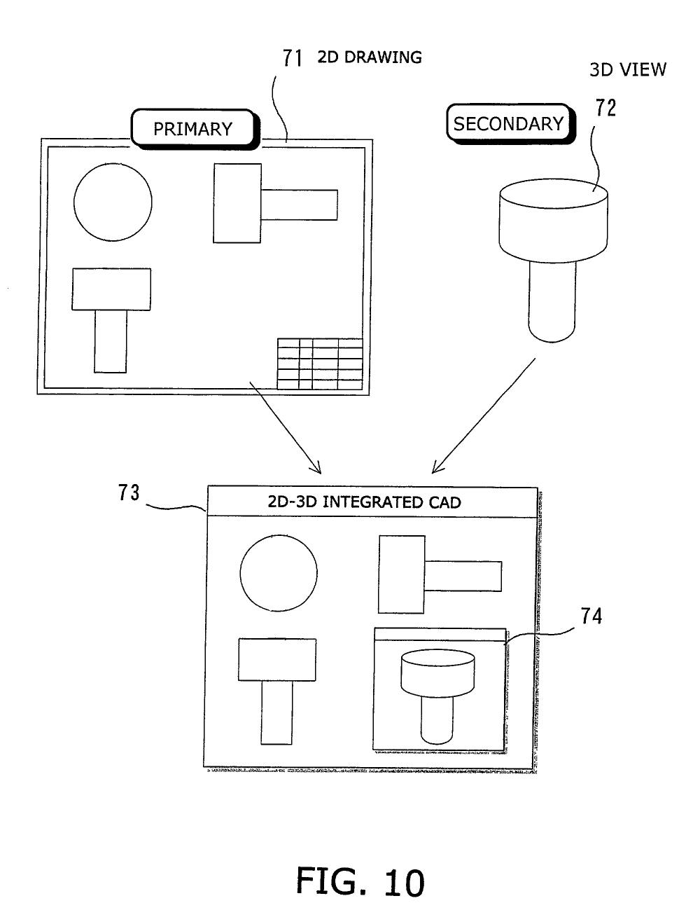

Referring to FIG. 10, a screen layout of the 2D-3D integrated CAD system is shown. With this system, the user first creates a two-dimensional drawing 71 of a desired solid object, specifying its shape and dimensions. The CAD system then builds a three-dimensional model, based on the two-dimensional drawing 71, and shows it in a three-dimensional view 72. If the user modifies the two-dimensional drawing 71, the CAD system automatically changes a corresponding part of the three-dimensional view 72 accordingly. In this sense, the two-dimensional drawing is the primary work space for the user, and the three-dimensional view 72 is the secondary. The monitor screen contains a main window 73 for providing the two-dimensional drawing 71 and a sub-window 74 for showing the three-dimensional view 72.

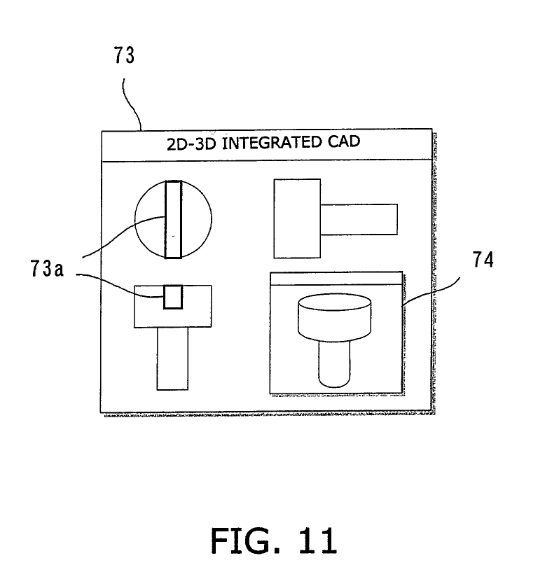

The user can apply an additional machining operation to the three-dimensional model 72 by defining another feature on the two-dimensional drawing 71. FIG. 11 shows an example of such a feature that is intended for an additional machining operation. As indicated by bold lines in the main window 73, the user creates a groove 73a on the top surface of the object being designed, specifying its profile and depth. The position of this groove 73a is determined simultaneously from its location on the projection views (top and front views in this example). The geometry of the groove 73a is then used to update the three-dimensional view 72.

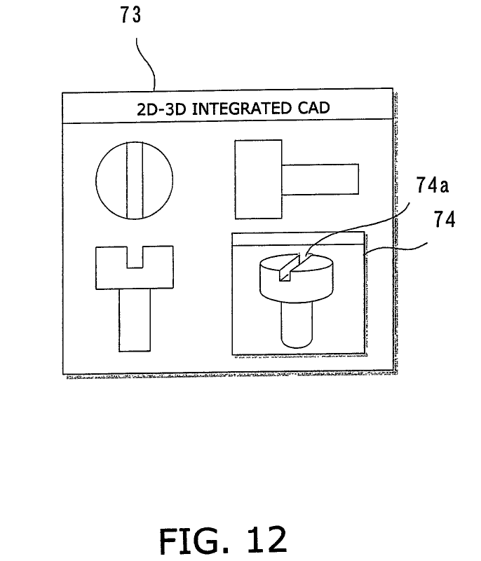

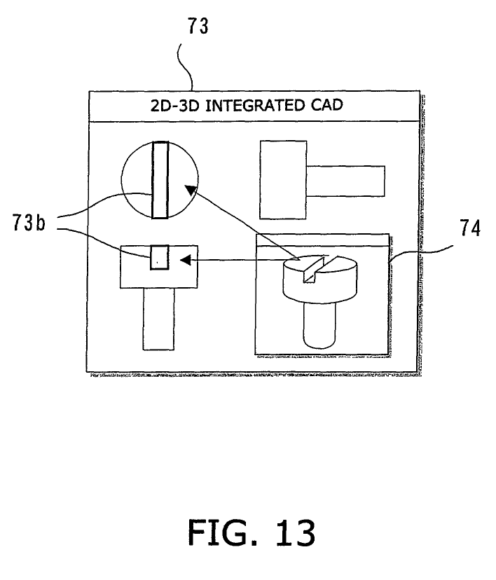

FIG. 12 shows the updated three-dimensional model after the specified machining operation (i.e., grooving) is applied. The three-dimensional view in the sub-window 74 now has a new feature 74a. Recall that the user defined this feature 74a in the two-dimensional drawing window 73 with his/her particular design intent, (i.e., grooving in this case). In such a context, the user would find it easier to select and manipulate the feature 74a in the two-dimensional drawing, rather than doing the same with the three-dimensional view in the sub-window 74. Accordingly, when the user wishes to select a particular feature, the CAD system will help him/her to accomplish it by providing projection views of the feature 74a on the two-dimensional drawing of the object for the purpose of temporary reference. Because of the consistency in their stored geometry data, the feature 74 is projected right on the contour of the groove 73a on the two-dimensional views. FIG. 13 shows the resultant drawing, on which the projection views 73b of the feature 74 are overlaid. The user can pick the three-dimensional feature 74 by pointing at a part of those projection views 73b.

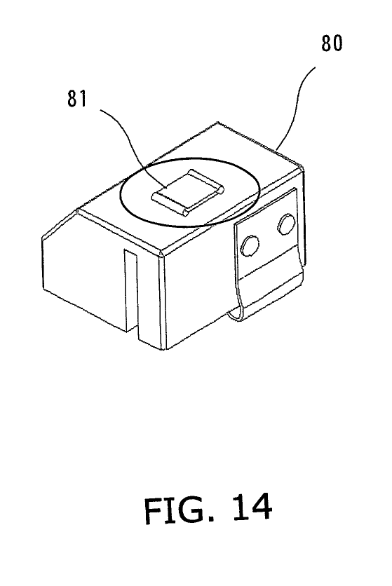

The above section has demonstrated the advantage of using two-dimensional views to specify a desired geometric feature particularly when the user takes a two-dimensional design approach to build a three-dimensional model. The method, however, is not limited to that situation, but it works effectively in some class of three-dimensional objects, whether or not they are based on the two-dimensional design approach. A specific example of such solid objects is shown in FIG. 14. In this example, a three-dimensional model 80 actually contains a hidden feature 81 which cannot be seen unless the user sets a “hidden line viewing” mode where the system explicitly shows the edges that are obscured by other objects.

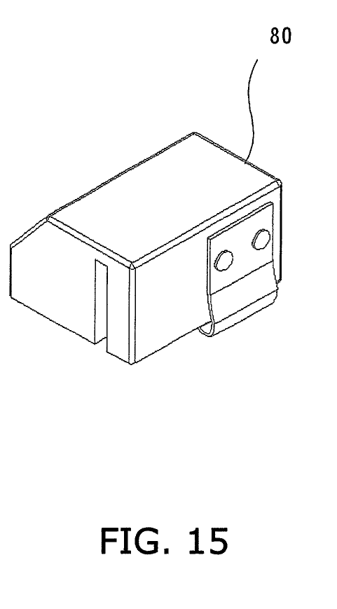

FIG. 15 shows a three-dimensional view of the object in which the hidden lines are removed. This view only provides the outer surface of the three-dimensional model 80. Without the hidden line viewing function, the user would not be able to pick any element of the internal structure of the three-dimensional model 80.

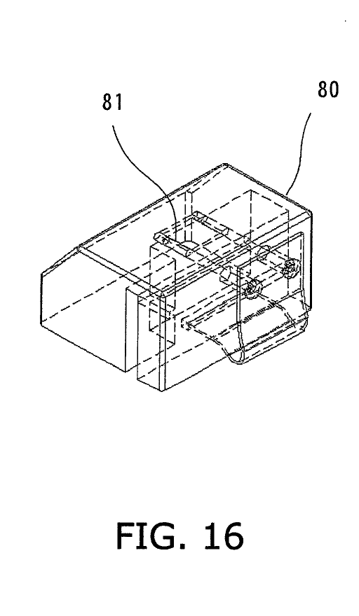

Theoretically, the above problem can be solved by activating the hidden line viewing function, and this would work fine when the object's structure was relatively simple. In some cases, however, the hidden line display function provides no help to the user. Referring to the example of FIG. 16, other complex internal structure becomes visible in the three-dimensional view of the object, making it difficult for the user to distinguish the desired feature 81 from others. Even if the user could successfully identify it, he/she should position the mouse cursor very carefully to pick the feature 81 without hitting other elements.

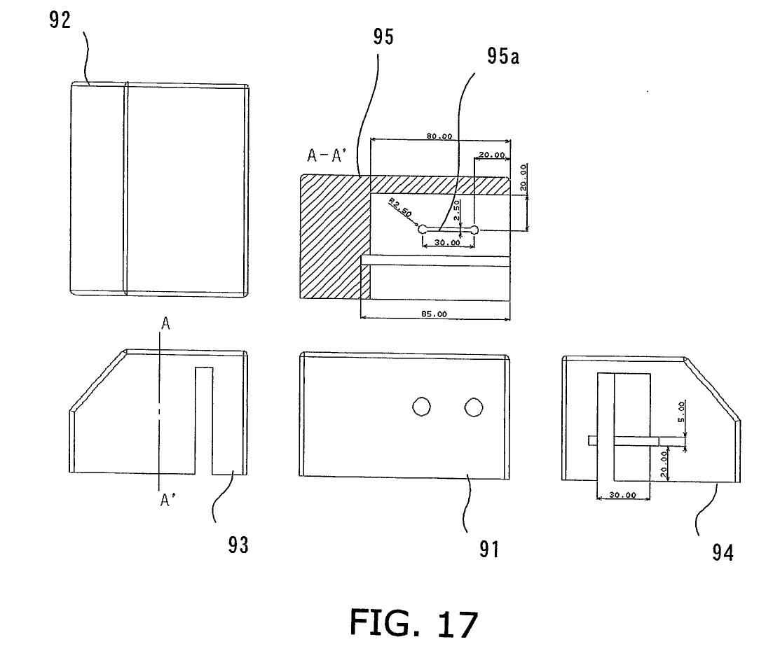

The present invention addresses the above problem by providing a two-dimensional drawing that represents the three-dimensional model and overlaying the shape of a feature (form of feature) on that drawing. This processing yields a set of orthographic projection views shown in FIG. 17. In this example, the following views are included in one two-dimensional drawing: front view 91, top view 92, left side view 93, right side view 94, and section view (A-A′) 95. Notice that the geometric feature 81 in question can be seen clearly in the section view (A-A′) 95. The user can pick the feature 81 by specifying its image 95a on such a two-dimensional drawing. In this way, the present invention improves the usability of CAD systems, enabling the user to specify a desired three-dimensional feature on a two-dimensional drawing, even in the case where three-dimensional views fail to show it distinguishably from other features thereon. With such intuitive feature selection functions, the user can work more efficiently to implement his/her ideas on a two-dimensional drawing.

The proposed processing mechanisms are actually implemented as software functions of a computer system. The process steps of the proposed CAD system are encoded in a computer program and stored in a computer-readable storage medium. The computer system executes this program to provide the intended functions of the present invention. Suitable computer-readable storage media include magnetic storage media and solid state memory devices. Other portable storage media, such as CD-ROMs and floppy disks, are particularly suitable for circulation purposes. Further, it will be possible to distribute the programs through an appropriate server computer deployed on a network. The program file delivered to a user is normally installed in his/her computer's hard drive or other local mass storage devices, which will be executed after being loaded to the main memory.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-aided design (CAD) system having a modeling mechanism that uses both two-dimensional and three-dimensional views of a solid object in an integrated manner, comprising:
two-dimensional drawing generating means for generating a two-dimensional drawing that represents a three-dimensional model being defined as a collection of three-dimensional geometric features;
two-dimensional drawing display means for displaying the generated two-dimensional drawing on a monitor screen;
graphic element selection means for selecting a graphic element contained in the two-dimensional drawing being displayed on the monitor screen; and
three-dimensional feature selection means for identifying one of the three-dimensional geometric features that corresponds to the graphic element selected by the graphic element selection means, and setting the identified geometric feature to a selected state for further manipulation.

2. The CAD system according to claim 1, wherein the two-dimensional drawing generated by the two-dimensional drawing generating means is a set of orthographic projection views of the three-dimensional model.

3. The CAD system according to claim 2, wherein:
the two-dimensional drawing display means displays a projection view of each geometric feature on the monitor screen, according to a line of sight defined for the two-dimensional drawing; and
the graphic element selection means selects a graphic element in the projection views of the geometric features provided by the two-dimensional drawing display means.

4. The three-dimensional CAD system according to claim 1, wherein:
the two-dimensional drawing generating means produces a two-dimensional view of each of the three-dimensional geometric features constituting the three-dimensional model, as well as maintains data about associations between graphic elements contained in the produced two-dimensional views and the three-dimensional geometric features; and
the three-dimensional feature selection means identifies one of the three-dimensional geometric features that corresponds to the graphic element selected by the graphic element selection means, based on the data maintained by the two-dimensional drawing generating means.

5. The three-dimensional CAD system according to claim 1, wherein the graphic element selection means makes the identified geometric feature appear with emphasis, in contrast to other features shown in a three-dimensional view on the monitor screen.

6. A computer-readable medium storing a CAD program which provides a modeling mechanism using both two-dimensional and three-dimensional views of a solid object in an integrated manner, the CAD program causing a computer to function as:
two-dimensional drawing generating means for generating a two-dimensional drawing that represents a three-dimensional model being defined as a collection of three-dimensional geometric features;
two-dimensional drawing display means for displaying the generated two-dimensional drawing on a monitor screen;
graphic element selection means for selecting a graphic element contained in the two-dimensional drawing being displayed on the monitor screen; and
three-dimensional feature selection means for identifying one of the three-dimensional geometric features that corresponds to the graphic element selected by the graphic element selection means, and setting the identified geometric feature to a selected state for further manipulation.
